(19) United States
(12) Patent Application Publication
(10) Pub. No.: US 2020/0020020 A1
(43) Pub. Date: Jan. 16, 2020

(54) EFFICIENT TRANSACTION SYSTEM AND METHOD OF USE

(71) Applicants: Justin Tibble, Port Huron, MI (US); Lawrence C. Cavanaugh, Port Huron, MI (US); Waleed Haddad, Port Huron, MI (US)

(72) Inventors: Justin Tibble, Port Huron, MI (US); Lawrence C. Cavanaugh, Port Huron, MI (US); Waleed Haddad, Port Huron, MI (US)

(21) Appl. No.: 16/031,119

(22) Filed: Jul. 10, 2018

(51) Int. Cl. G06Q 30/06; G06Q 20/12; G06Q 50/12

(52) U.S. Cl. CPC G06Q 30/0635; G06Q 50/12; G06Q 20/12

(57) ABSTRACT

An efficient transaction system allows a purchasing party to coordinate with a product provider to have a product ready when the purchaser arrives at the location of the product. The system places the purchaser and provider in communication through a portal and computing devices. The portal is able to track the location of the purchaser to further enhance the preparation of the product and transfer payment thereof.

### BACKGROUND

### 1. Field of the Invention

The present invention relates generally to commercial systems, and more specifically, to systems for improving the placement, delivery and payment for services or goods.

### 2. Description of Related Art

Commercial systems are well known in the art and are effective means to enable a first party to provide a good or service to a second party for an agreed upon compensation. For example, FIG. 1 depicts a conventional food ordering system 101 having a location 103 where a menu of food 105 is offered for sale. A customer 107 arrives at the location 103 and selects from the menu of food 105 items that are desired. The predetermined value from the customer is exchanged and the items of food are either prepared or served from previously prepared lots.

One of the problems commonly associated with system 101 is its limited efficiency. For example, the food that is purchased requires time to prepare for which the customer must wait, resulting in lost time, while it is understood that this time could be well spent at the location it is also noted that it could be better spent in many situations elsewhere.

Alternatively, the food items are prepared with the expectation that they will be purchased in the near future resulting in the food not being as fresh as possible detracting from its taste, presentation or the like. This also results in wasted food when it is not purchased.

Accordingly, although great strides have been made in the area of food ordering systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common food ordering system;

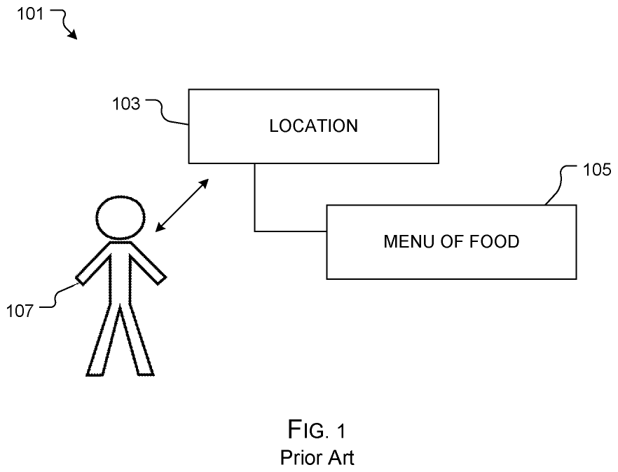

FIG. 2 is a diagram of an efficient transaction system in accordance with a preferred embodiment of the present application;

FIG. 3 a flow chart of the system of FIG. 2 in use;

FIG. 4 is a diagram of an alternative embodiment of the system of FIG. 2;

FIG. 5 is a diagram of an alternative embodiment of the system of FIG. 2; and

FIG. 6 is a flowchart of the preferred method of use of the system of FIG. 2

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional food ordering systems. Specifically, the invention of the present application reduces or eliminates the time between the arrival of the customer at the location where the products are available for sale and when the purchased items are delivered to them. In addition, the items being purchased are able to be prepared only when an order is confirmed eliminating waste. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

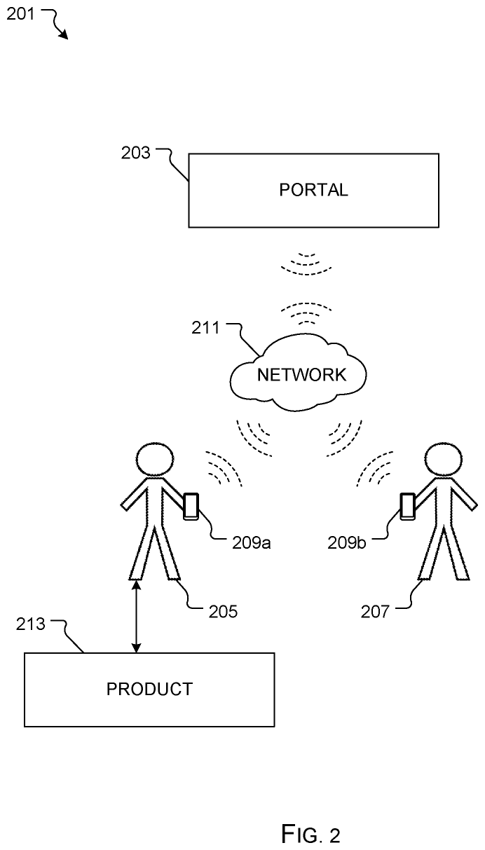

Referring now to the drawings wherein like reference characters identify corresponding or similar elements throughout the several views, FIG. 2 depicts a diagram of an efficient transaction system in accordance with a preferred embodiment of the present application. It will be appreciated that system 201 overcomes one or more of the above-listed problems commonly associated with conventional food ordering systems.

In the contemplated embodiment, system 201 includes a portal 203 in communication with a provider 205 and a purchaser 207 via computing devices 209 and a network 211. The provider 205 having product 213 for sale, the product could be a good, service or the like.

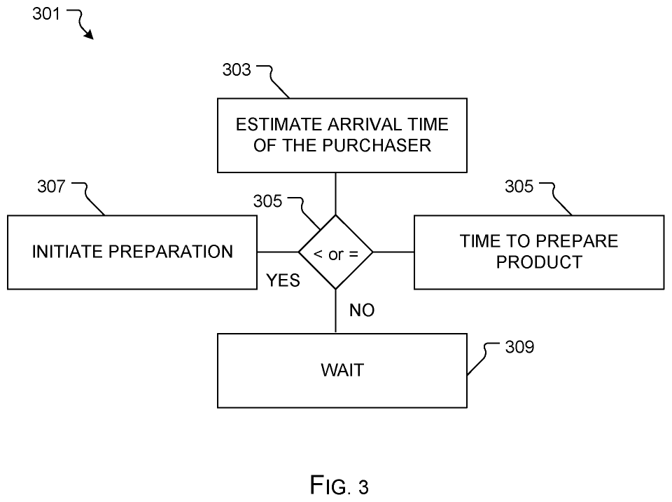

In use, as depicted in FIG. 3, the purchaser 207 places an order for the product 213 via the portal 203 which access the location of the purchaser 207 and estimates a time of arrival 303. The portal 203 then compares the time required to prepare 305 with the interval of the ETA 303 and signals the provider 205 to begin the preparation so that the product 213 is ready when the purchaser 207 arrives. If the ETA 303 is not equal or less than the preparation time 305 the portal delays 309 the preparation.

It should be appreciated that one of the unique features believed characteristic of the present application is that the product for sale is coordinated with the physical location and ETA to the location where the product is available to ensure that the product is ready when the purchaser thereof arrives.

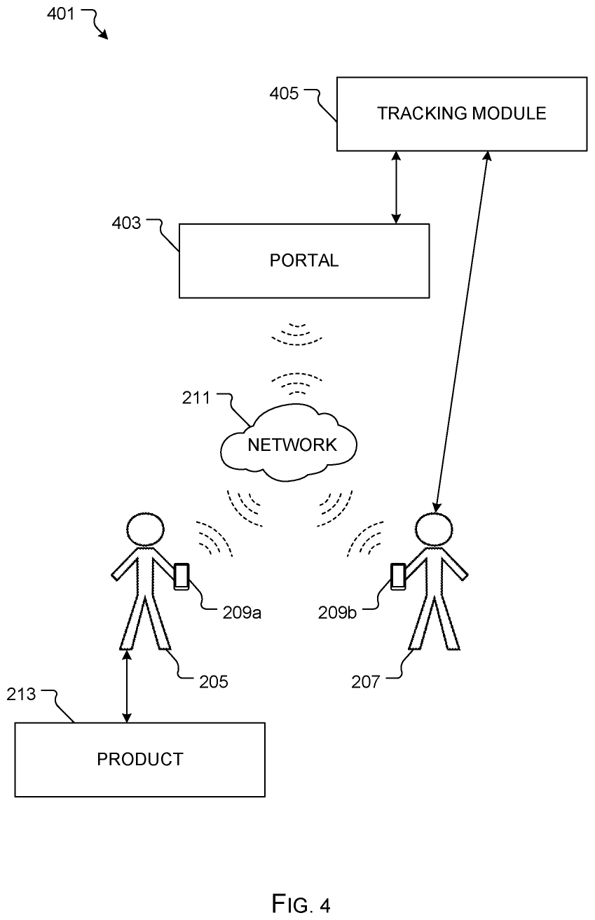

In an alternative embodiment 401 depicted in FIG. 4, similar features as system 201 are included wherein portal 403 includes a tracking module 405 to monitor the location of the purchaser 207 via their computing device 209 so that when they reach a point where their arrival at the location is the same amount of time away as that required to prepare the product 213.

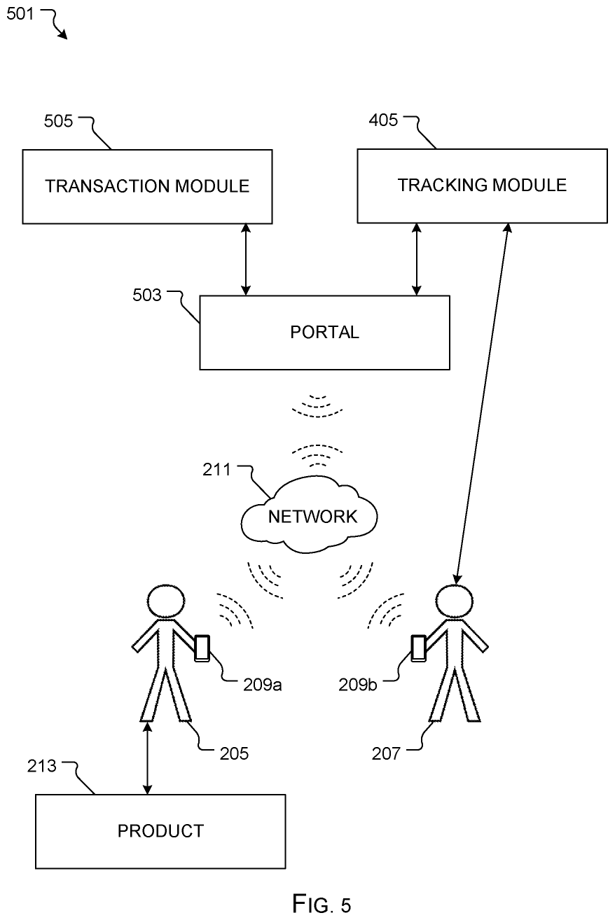

Referring now to FIG. 5, yet another alternative embodiment 501 is depicted. Embodiment 501 including similar features as embodiment 401 wherein the portal 503 includes a tracking module 505 that uses the arrival of the purchaser 207 in a selected location 505 to initiate a transaction 507 for payment of the product 213.

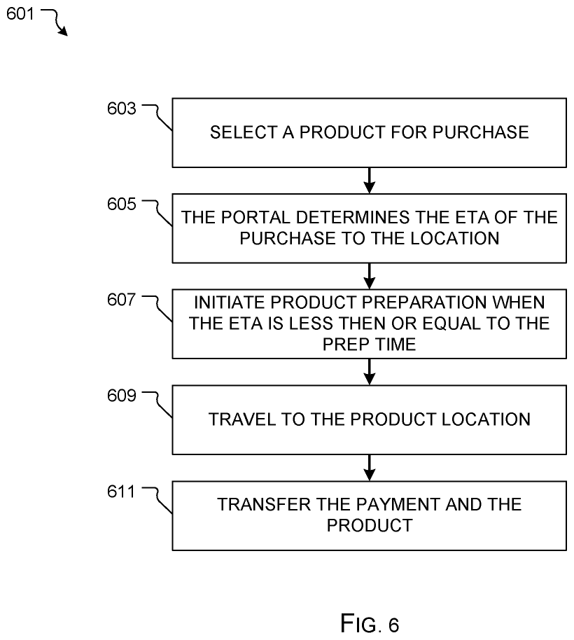

The preferred method of use of system 201 is depicted in FIG. 6. Method 601 including a purchaser initiating the transfer of a product 603, the portal determining the estimated time of arrival to the location where the product is available 605, the portal initiating preparation of the product to coincide with the arrival of the purchaser 607, the purchaser traveling to the location of the product 609 and transferring payment and the product 611.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. An efficient transaction system comprising:
a portal in communication with a plurality of computing devices; and
at least one of the plurality of computing devices being used by a purchaser;
wherein the estimated time for the purchaser to arrive at the location where a product is available is used by the portal to enable the product being ready at the time the purchaser arrives.

2. The system of claim 1 wherein the portal tracks the location of at least one computing device to initiate the preparation of the purchased product.

3. The system of claim 1 wherein the portal uses the location of at least one computing device to initiate a transaction to make payment for the product.

4. The method of coordinating arrival of a purchaser with the product being ready, comprising:
a purchaser initiating the transfer of a product;
the portal determining the estimated time of arrival to the location where the product is available;
the portal initiating preparation of the product to coincide with the arrival of the purchaser;
the purchaser traveling to the location of the product; and
transferring payment and the product.
